(19) United States
(12) Patent Application Publication
(10) Pub. No.: US 2018/0231085 A1
(43) Pub. Date: Aug. 16, 2018

(54) NON-ASBESTOS FRICTION MATERIAL

(71) Applicant: ADVICS CO., LTD., Kariya-shi, Aichi-ken (JP)

(72) Inventors: Osayoshi KATO, Nagoya-shi (JP); Masaaki KOBAYASHI, Obu-shi (JP)

(73) Assignee: ADVICS CO., LTD., Kariya-shi, Aichi-ken (JP)

(21) Appl. No.: 15/510,438

(22) PCT Filed: Feb. 29, 2016
(86) PCT No.: PCT/JP2016/055976

§ 371 Date: Mar. 10, 2017

(30) Foreign Application Priority Data
Feb. 27, 2015 (JP) 2015-038409

(51) Int. Cl. F16D 69/02; C08K 7/00; C08K 3/34; C08K 11/00; C08K 3/22; C08K 3/30

(52) U.S. Cl. CPC F16D 69/026; C08K 7/00; C08K 3/34; C08K 11/00; C08K 3/22; C08K 3/30; C08K 2003/2203; C08K 2201/019; C08K 2003/2265; C08K 2003/2244; C08K 2003/2206; C08K 2003/3045; C08K 2003/2237; C08K 3/346

(57) ABSTRACT

A non-asbestos friction material contains a fibrous substance, a binder, and a friction modifier. The material contains no copper components, no carbonaceous raw materials, and no metal sulfides but contains an inorganic material having a laminar crystal structure and being different from the copper components, the carbonaceous raw materials, and the metal sulfides. Preferably, the inorganic material is at least one inorganic material selected from titanates, talc, kaolin, mica, vermiculite, and smectite.

### TECHNICAL FIELD

The present invention relates to a non-asbestos friction material used in, for example, a disk brake with vehicle parking mechanism.

### BACKGROUND ART

In the past, for example, when a disk brake with parking mechanism is left uncontrolled for a long period of time while a parking brake is activated, i.e., when a friction material is kept pressed against a rotor for a long period of time, the rotor and the friction material may be fixed to each other by rust. Such a phenomenon is generally called rust fixing. As a technique to suppress the rust fixing, for example, a technique described in Patent Literature 1 is known.

In the literature, in a friction material for disk brake pad containing no copper components, a friction material composition which contains specified volumes of a binder, organic fibers, a metal sulfide lubricant agent serving as a lubricant agent, carbonaceous lubricant agent, titanates, wollastonite serving as an inorganic friction modifier, an inorganic friction modifier having a predetermined Mohs hardness, an organic friction modifier, and a pH regulator and which does not contain a material having a Mohs hardness higher than the above Mohs hardness, a simple metal except for copper, and an alloy except for a copper alloy is used to improve abrasion resistance and resistance to rust fixing.

However, the presence of a metal sulfide or a carbonaceous raw material contained in a friction material is considered to be one of the causes of the rust fixing. More specifically, sulfate ions generated by thermal decomposition of the metal sulfide are considered to enhance generation of rust on a rotor surface. On the other hand, the carbonaceous raw material is considered to cause electric corrosion between the carbonaceous raw material and the rotor because of the high electric conductivity of the carbonaceous raw material.

The friction material described in Patent Literature 1 contains a metal sulfide or a carbonaceous raw material, and the resistance to rust fixing may be insufficient.

In particular, in recent years, in conjunction with high functionalization of vehicles such as electric control of a parking operation in a disk brake with parking mechanism, a friction material which satisfies resistance to rust fixing, abrasion resistance, and stability of a friction coefficient in a high order is desired. For this reason, techniques which have been proposed up to now do not fully satisfy requirements of customers.

### BACKGROUND ART

### Patent Literature

Patent Literature 1: JP 2014-159871 A

### SUMMARY OF THE INVENTION

### Technical Problem

The present invention aims to provide a non-asbestos friction material which is excellent in resistance to rust fixing, abrasion resistance, and stability of a friction coefficient.

### Solution to Problem

In order to solve the above problem, the present invention provides a non-asbestos friction material containing a fibrous substance, a binder, and a friction modifier, wherein the material contains no copper components, no carbonaceous raw materials, and no metal sulfides but contains an inorganic material having a laminar crystal structure and being different from the copper components, the carbonaceous raw materials, and the metal sulfides.

According to the invention, since the non-asbestos friction material does not contain any copper components and carbonaceous raw materials, both of which have a high electric conductivity and are considered to easily generate rust, resistance to rust fixing is improved. In addition, no metal sulfides which generate sulfate ions enhancing generation of rust are contained in the friction material to contribute to improvement of resistance to rust fixing. On the other hand, since the copper components, carbonaceous raw materials, or metal sulfides are not contained in the friction material, lubricating property caused by the materials cannot be expected. However, with respect to this point, the inorganic material having the laminar crystal structure improves the lubricating property. In this manner, the abrasion resistance is improved, and, consequently, the stability of a friction coefficient is improved. Thus, the non-asbestos friction material is excellent in the resistance to rust fixing, abrasion resistance, and stability of a friction coefficient.

### BRIEF DESCRIPTION OF DRAWINGS

FIG. 1 is a diagram showing a summary of compositions of friction raw materials in examples and comparative examples of friction materials according to the embodiment and performance assessments thereof.

### EMBODIMENT

An embodiment of the present invention will be described below in detail. The present invention is not limited by the following embodiment as long as the invention does not depart from the spirit and scope of the invention.

### 1. Friction Material

An embodiment of a friction material according to the present invention will be described in detail below. The friction material according to the present invention is a non-asbestos friction material containing a fibrous substance, a binder, and a friction modifier, wherein the material contains no copper components, no carbonaceous raw materials, and no metal sulfides but contains an inorganic material (hereinafter simply referred to as an “inorganic material having a laminar crystal structure”) having a laminar crystal structure and being different from the copper components, the carbonaceous raw materials, and the metal sulfides.

The friction material according to the present invention contains the inorganic material having the laminar crystal structure and containing the fibrous substance, the binder, and the friction modifier. However, the friction material may contain another friction raw material used when the friction material is manufactured except for copper components, carbonaceous raw materials, and metal sulfides.

As a fibrous substrate to be used, organic fibers such as aramid fibers (for example, aramid pulp), cellulose fibers, or acrylic fibers, or inorganic fibers such as glass fibers, rock wool, ceramic fiber, or wollastonite are exemplified. Of these fibers, one or two or more types may be used. The aramid pulp or wollastonite can be given as a particularly preferable example. Although the composition ratio of the fibrous substrate is not especially limited to a specific ratio, the fibrous substrate need only be added to the friction material such that a ratio of 4 to 15 wt % to the entire weight of the friction material is approximately set.

The binder has a role of binding components of the friction material, and a known material can be used as the binder. Preferably, a thermosetting resin such as a phenol resin, a melamine resin, or an epoxy resin, a modified product thereof, or the like is exemplified. Of these materials, one or two or more types may be used. The phenol resin can be given as a particularly preferable example. Although a composition ratio of the binder is not especially limited to a specific ratio, the binder need only be added to the friction material such that a ratio of 6 to 16 wt % to the entire weight of the friction material is approximately set.

The friction modifier has a role of adjusting friction performance such as a friction coefficient or abrasion of a friction material, and the friction modifier can contain various fillers, an abradant, a lubricating material, and the like. Friction dusts such as cashew dust or rubber dust, zirconium oxide, zirconium silicate, iron oxide, calcium hydroxide, calcium carbonate, barium sulfate, magnesium oxide, or the like can be given as examples. Of these materials, one or two or more types may be used. Cashew dust, zirconium oxide, iron oxide, calcium hydroxide, and barium sulfate can be given as preferable examples. Although a composition ratio of the friction modifier is not especially limited to a specific ratio, for example, the friction modifier need only be added to the friction material such that a ratio of 40 to 70 wt % to the entire weight of the friction material is approximately set.

As described above, the friction material according to the present invention contains no copper components, no carbonaceous raw materials, and no metal sulfides. In this manner, since the friction material does not contain the copper components or the carbonaceous raw materials, both of which have high electric conductivity and are considered to easily generate rust, resistance to rust fixing is improved. In addition, sulfate ions which enhance generation of rust are not contained in the friction material to contribute to improvement of resistance to rust fixing.

In this case, as the copper components, for example, copper (simple metal), a copper alloy, a copper compound, and the like can be given, and, as carbonaceous raw materials, for example, graphite, coke, carbon black, and the like can be given. As the metal sulfides, molybdenum disulfide, molybdenum trisulfide, ferric sulfide, zinc sulfide, tin sulfide (SnS, SnS₂), tungsten sulfide, complex sulfide, and the like can be given. All the materials have long been used widely as ingredients of a friction material to improve the lubricating property, consequently, abrasion resistance and the stability of a friction coefficient.

In this manner, the copper components, the carbonaceous raw materials, and the metal sulfides have been importantly used to improve the abrasion resistance and the stability of a friction coefficient of the friction material. When these materials are not contained in the friction material, consequently, such advantageous effects caused by the materials cannot be expected. More specifically, the materials can improve resistance to rust fixing. In contrast to this, even though the materials are simply prevented from being contained in the friction material, the abrasion resistance and the stability of a friction coefficient are hard to be improved or cannot be improved.

In order to solve the dilemma, the present inventors have conducted intensive studies. As a result, the present inventors have found that in a case where an inorganic material having a laminar crystal structure is contained in the friction material, it is possible to improve the lubricating property, consequently, abrasion resistance, and the stability of a friction coefficient.

In this case, as the inorganic material having a laminar crystal structure, for example, titanates such as lithium potassium titanium oxide or magnesium potassium titanium oxide, talc, kaolin, mica, vermiculite, smectite, or the like (all the materials having laminar crystal structures) can be given. One or two or more types of these materials may be used. Preferably, of the materials, titanates are contained in the friction material. More preferably, titanates and talc of a blending quantity (In this case, the blending quantity is a weight ratio to the weight of the composition of the friction material. The unit is a weight percent.) smaller than that of the titanates may be contained (for example, see Example 3 (will be described below) and Example 7 to Example 9) in the friction material, or titanates and at least one of mica and vermiculite of a blending quantity smaller than that of the titanates may be contained (for example, see Example 5 and Example 7 to Example 9). Titanates, talc of a blending quantity smaller than that of the titanates, and at least one of mica and vermiculite of a blending quantity smaller than that of the titanates may be contained in the friction material (for example, see Example 7 to Example 9).

In the embodiment, in order to make resistance to rust fixing more preferable, not only copper or a copper alloy, but also a metal (for example, a simple metal such as iron, aluminum, or tin or an alloy of these metals) except for the copper or the copper alloy are not contained. More specifically, a metal having a high electric conductivity and considered to easily generate rust is not contained in the friction material to try to further improve the resistance to rust fixing. Also in this case, as a matter of course, since the metal is not contained in the friction material, it is impossible to expect improvement in the lubricating property, consequently, abrasion resistance and the stability of a friction coefficient that are obtained when the metal is thermally melted. However, the present inventors have found that in a case where the inorganic material having the laminar crystal structure is contained, it is possible to improve the abrasion resistance and the stability of a friction coefficient enough to be able to cover the shortcomings.

The friction material of the present invention can be applied to, for example, a disk brake pad with vehicle parking mechanism. However, the application of the friction material is not limited to the disk brake pad. The friction material can be applied to a disk brake pad which does not have a parking mechanism or, for example, a technique requiring a conventional known friction material such as a brake shoe. The manufactured friction material can be integrated with, for example, a plate-like member such as metal plate serving as a back plate and used as a brake pad.

### 2. Method of Manufacturing Friction Material

Details of an embodiment about a method of manufacturing a friction material according to the present invention will be described below. The method of manufacturing a friction material according to the present invention has a thermosetting step of heating a molded article obtained by heating and molding a mixture of friction raw materials containing the fibrous substrate, the binder, the friction modifier, and the inorganic material having a laminar crystal structure at 160° C. or more and less than 300° C. (200° C. in the notification of the invention) for 2 to 8 hours (4 hours in the notification of the invention) to cure the binder.

The friction raw materials such as the fibrous substrate, the binder, and the friction modifier are checkweighed and equally mixed with each other. The mixing can be performed by putting the materials in a mixer such as a Henschel mixer or a Loedige mixer. For example, the materials are mixed with each other at normal temperature for about 10 minutes. At this time, the materials may also be mixed with each other while being cooled by a known cooling means to prevent the mixer from increasing in temperature.

A predetermined amount of the obtained mixture is checkweighed, pressured, and preliminarily molded. The resultant mixture is hot-molded while being pressured. The hot molding can be performed by, for example, putting the mixture in a hot mold and performing hot pressing or the like. At this time, the materials may be overlapped on a back plate of a plate-like member such as a metal plate and put into a hot mold. As the back plate, a back plate which is washed in advance and then subjected to proper surface treatment and has an adhesive agent coated on a side on which the preliminarily molded mixture is placed can be used. The hot molding is preferably performed such that a molding temperature is set at 140° C. to 180° C., particularly preferably, 160° C., a molding pressure is set to 100 to 250 kgf/cm², particularly preferably, 200 kgf/cm², and a molding time is set at 3 to 15 minutes, particularly preferably, 10 minutes.

The obtained molded article is further heated to finish the curing of the binder. The thermosetting is performed such that a curing temperature is preferably set at 160° C. or more and less than 300° C., particularly preferably, 180° C. or more and less than 230° C. A curing time is in reverse proportion to the curing temperature. When the curing temperature is set at a high temperature, the curing can be performed within a short period of time, and when the curing temperature is set at a low temperature, a time required for curing becomes long. More preferably, the curing can be performed within 2 to 8 hours.

In this manner, the inorganic material having a laminar crystal structure is distributed to not only the surface of the friction material but also the entire area including the inside of the friction material.

### Examples

The present invention will be described below with reference to examples. However, the present invention is not limited to the examples.

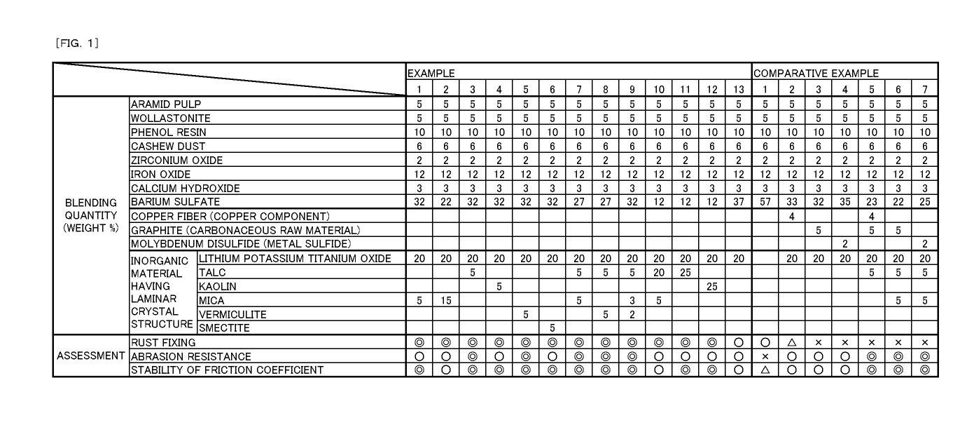

In the examples, a friction raw materials were combined with each other according to blending quantities shown in FIG. 1 to obtain compositions of friction materials of Examples 1 to 13 and Comparative Examples 1 to 7. A unit of the blending quantities of the friction raw materials in the table is a weight percent to the entire weight of the compositions of the friction materials. The compositions of each of the friction materials are heated under pressure on the condition that a molding temperature was set at 160° C., a molding pressure was set at 200 kgf/cm², and a molding time was set at 10 minutes. Subsequently, the molded products were cured at 200° C. for 4 hours.

The manufactured friction materials according to Examples 1 to 12 and Comparative Examples 1 to 7 were assessed with respect to the following items.

### (Rust Fixing)

A rust fixing test was performed according to JIS D4414 (rust fixing test method) to measure and assess rust fixing forces at four stages. More specifically, depending on the magnitudes of the rust fixing forces, less than 100 N was determined as “⊚”, 100 N or more and less than 200 N was determined as “◯”, 200 N or more and less than 300 N was determined as Δ and 300 N or more was determined as “x”.

### (Abrasion Resistance)

An abrasion test was performed according to JASO C427 to measure abrasion losses of the friction materials, to convert the abrasion losses into abrasion losses per the predetermined number of times of braking, and assess the converted abrasion losses at four stages. More specifically, depending on the magnitudes of the converted values, less than 0.20 mm was determined as “⊚”, 0.20 mm or more and less than 0.25 mm was determined as “◯”, 0.25 mm or more and less than 0.30 mm was determined as Δ, and 0.30 mm or more was determined as “x”.

### (Stability of Friction Coefficient)

Average friction coefficients were measured according to JASO C407 in an environment in which a temperature was set at 20° C. and a humidity was set to 58% to assess the stabilities of the friction coefficients at four stages. More specifically, a friction material being very excellent in stability of a friction coefficient was determined as “⊚”, a friction material being excellent was determined as “◯”, a friction material being poor was determined as Δ, and a friction material being very poor was determined as “x”.

The results are shown in FIG. 1. In all Examples 1 to 13 of the present invention, preferable results can be obtained with respect to the rust fixing, abrasion resistance, and stability of a friction coefficient. In this manner, it was found that in a case where copper components, the metals described above, carbonaceous raw materials, or metal sulfides are not contained, and an inorganic material having a laminar crystal structure is contained, it is possible to obtain a friction material being excellent in rust fixing, abrasion resistance, and stability of a friction coefficient. In contrast to this, in Comparative Example 1 in which a friction material does not contain an inorganic material having a laminar crystal structure, abrasion resistance and stability of a friction coefficient were poor. For this reason, it was found that the abrasion resistance and the stability of a friction coefficient which were confirmed in the embodiment of the present invention were caused by the inorganic material having a laminar crystal structure.

In Comparative Examples 2 to 7 in which each friction material contains at least one of copper components, carbonaceous raw materials, and metal sulfides, even though “◯” or “⊚” could be acquired with respect to the stability of a friction coefficient, it is observed that the rust fixing property is poor.

1-4. (canceled)

5. A non-asbestos friction material containing a fibrous substance, a binder, and a friction modifier, wherein the material contains no copper components, no carbonaceous raw materials, and no metal sulfides but contains an inorganic material having a laminar crystal structure and being different from the copper components, the carbonaceous raw materials, and the metal sulfides, and, as the inorganic material, titanates and at least one of talc and vermiculite of a blending quantity smaller than that of the titanates are employed.

6. The non-asbestos friction material according to claim 5, wherein, as the inorganic material, mica of a blending quantity smaller than that of the titanates is employed.
